(19) United States
(12) Patent Application Publication
(10) Pub. No.: US 2007/0022223 A1
(43) Pub. Date: Jan. 25, 2007

(54) ELECTRONIC APPARATUS AND METHOD FOR IMPLEMENTING AN INTELLIGENT SLEEP MODE

(76) Inventors: Han-Che Wang, Shenzhen (CN); Xiao-Guang Li, Shenzhen (CN); Kuan-Hong Hsieh, Shenzhen (CN); Wen-Chuan Lian, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,782

(22) Filed: May 3, 2006

(30) Foreign Application Priority Data
Jul. 22, 2005 (CN) 200510036147.7

(51) Int. Cl. G06F 3/00

(52) U.S. Cl. 710/15

(57) ABSTRACT

A method for implementing an intelligent sleep mode on an electronic apparatus includes the steps of: tracking an elapsed time where no operational input is received; decreasing output volume when the tracked time is equal to a predetermined time period if the output volume is greater than a predetermined volume; and turning off the electronic apparatus when satisfying a predetermined requirement, wherein the predetermined requirement may be that the current volume is equal to or less than the predetermined volume or that a time tracked by the time reaches the second predetermined time period. A related electronic apparatus is also disclosed.

### TECHNICAL FIELD

The present invention relates generally to an electronic apparatus and method for implementing an intelligent sleep mode.

### GENERAL BACKGROUND

Listening to audio generation apparatuses helps many people relieve stress and tiredness. However, it is easy to fall asleep when listening to the audio generation apparatus. When a listener falls asleep while the audio generation apparatus is still on, electricity is wasted, and may also shorten the working lifetime of the audio generation apparatus.

To prevent these problems, a listener can take advantage of the so-called sleep mode function of an audio generation apparatus when he/she falls asleep. There are numerous technologies regarding the sleep mode function of audio generation apparatuses, such as an invention. According to the invention, when a predetermined sleep mode time has passed, the audio generation apparatus is powered off.

However, when the listener has fallen asleep and the predetermined sleep mode time has not passed, the audio generation apparatus continues to play sounds, which wastes the power of the battery thereof. In addition, there may be the case where a predetermined sleep time has passed causing the audio generation apparatus to turns off, yet the listener has not fallen asleep. Causing the listener to turn on the audio generation apparatus again in order to continue listening to music, a very inconvenient procedure.

Thus, what is needed is an electronic apparatus and method which not only reduces unnecessary consumption of power, and provides a double checking mechanism to ensure that the usage of the electronic apparatus.

### SUMMARY

An electronic apparatus for implementing an intelligent sleep mode according to a preferred embodiment of the present invention includes an input unit, a volume control unit, a timer, and a center control unit. The center control unit is connected with the input unit and the timer. The center control unit is for controlling the volume control unit to decrease volume output when no operational input is received by the input unit every first predetermined time period, and for turning off the electronic apparatus when satisfying a predetermined requirement, wherein the predetermined requirement may be that the current volume is equal to or less than the predetermined volume or that a time tracked by the time reaches the second predetermined time period.

A method for implementing an intelligent sleep mode is also disclosed. The method provides an electronic apparatus, the electronic apparatus including a timer. The method includes the steps of: (a) the timer tracking an elapsed time where no operational input is received; (b) decreasing output volume when the tracked time is equal to a predetermined time period; and (c) turning off the electronic apparatus when satisfying a predetermined requirement, wherein the predetermined requirement may be that the current volume is equal to or less than the predetermined volume or that a time tracked by the time reaches the second predetermined time period.

Other advantages and novel features will be drawn from the following detailed description of the embodiments with reference to the attached drawings, in which:

### BRIEF DESCRIPTION OF DRAWINGS

FIG. 1 is a block diagram of hardware infrastructure of an electronic apparatus for implementing an intelligent sleep mode in accordance with a preferred embodiment of the present invention; and

FIG. 2 is a flowchart of a preferred method for implementing an intelligent sleep mode on the electronic apparatus of FIG. 1.

### DETAILED DESCRIPTION OF THE PREFERRED EMBODIMENTS

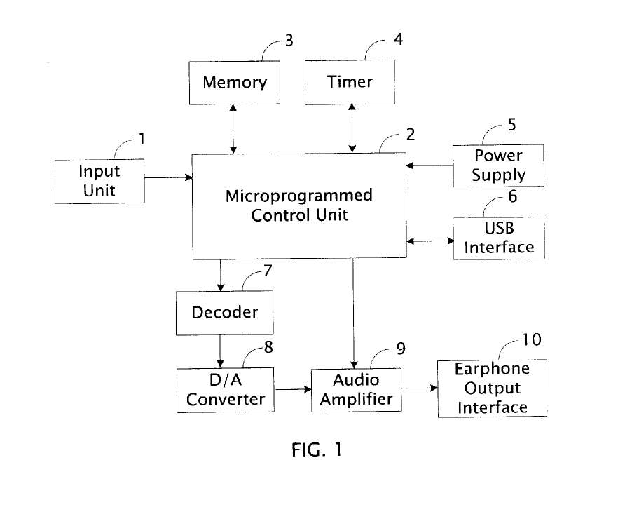

FIG. 1 is a block diagram of hardware infrastructure of an electronic apparatus for implementing an intelligent sleep mode (hereinafter, “the electronic apparatus”) in accordance with the preferred embodiment of the present invention. When a system time of the electronic apparatus reaches a predetermined time and no operational input is received over a time period, the electronic apparatus starts up the sleep mode and gradually decreases the playing parameter thereof. The playing parameter may be volume and/or the brightness. The predetermined time can be preset in advance. The electronic apparatus may be a television, a media player, or an E-book. For simplicity, in the embodiment, the electronic apparatus adopts a media player as an example, correspondingly, the playing parameter takes example for the volume. The media player includes an input unit 1, a Microprogrammed Control Unit (MCU) 2, a memory 3, a timer 4, a power supply 5, and an audio outputting portion. The audio outputting portion further includes a decoder 7, a Digital/Analog (D/A) converter 8, an audio amplifier 9, and an earphone output interface 10.

The media player further includes a Universal Serial Bus (USB) Interface 6 for connecting the MCU 2 to an external electronic device (not shown) for downloading audio files therefrom into the memory 3. The audio files may be in a Moving Picture Experts Group (MPEG) audio layer 3 (MP3) format, an Advanced Audio Coding (MC) format, or any other suitable format. The memory 3 further stores information used or generated by the media player, such as preset parameters. The preset parameters include a sleep mode time T0, a first time period A, a second time period, and a minimum volume. The minimum volume may be a predetermined value or a certain percent of an initial volume.

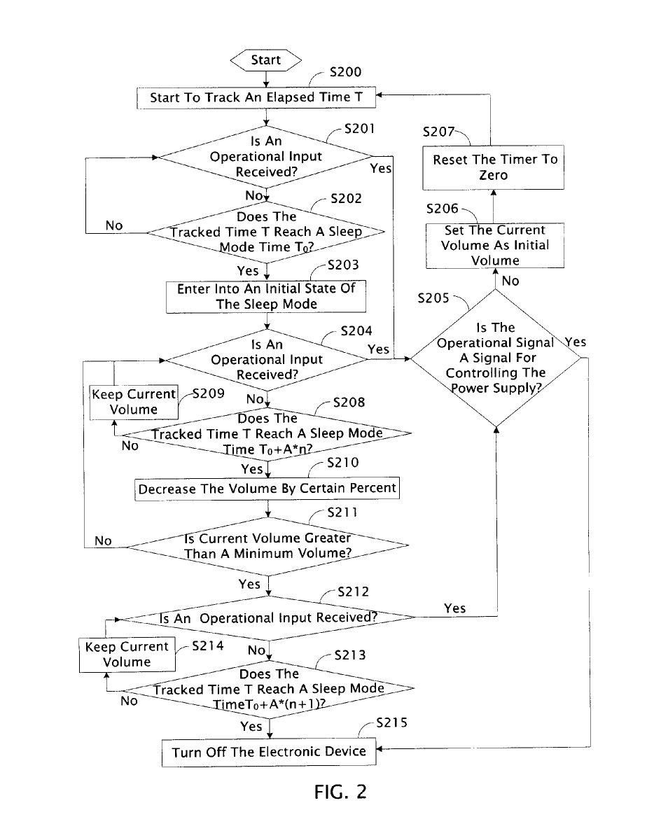

The input unit 1 receives a user operation, and generates a operation signal to the MCU 2. Once the intelligent sleep mode is started up, the timer 4 tracks an elapsed time T during which no operational input is received by the input unit 1. The MCU 2 is provided for controlling outputs of audio signals, and performing actions described below. The actions include: entering into an initial state of a sleep mode when the tracked time T reaches the sleep mode time T0; decreasing a volume of the media player if no operational input is received by the input unit 1 every time period A during sleep mode; and turning off the media player when a current volume is equal to or less than the minimum volume and no operation input is received by the input unit 1. Alternatively, the MCU 2 turns off the media player after the second time period reaches. The second time period is a sum of all the first predetermined time tracked by the timer. In FIG. 2 described-below flowchart of a preferred method takes that the MCU turns off the media player when a current volume is equal to or less than the minimum volume and no operation input is received by the input unit 1 the as example. Furthermore, a decreased amount of the decreasing volume can be a certain percent of an initial volume of the media player or be a predetermined value.

The decoder 7 decodes audio files into digital audio signals. The D/A converter 8 converts the digital audio signals into analog audio signals. The MCU 2 further controls the audio amplifier 9 to increase or decrease intensities of the audio signals according to a signal for adjusting volume from the input unit 1. Accordingly, the audio amplifier 9 increases or decreases the volume under the control of the MCU 2, and outputs the increased or decreased audio signals via an earphone output interface 10. The earphone output interface 10 is for accepting an earphone (not shown), and thus to listen to the sound corresponding to the analog audio signals.

FIG. 2 is a flowchart of a preferred method for implementing an intelligent sleep mode on the electronic apparatus of FIG. 1. In step S200, the MCU 2 starts the timer 5 to track an elapsed time T during which no operational input is received by the input unit 1. In step S201, the input unit 1 detects in real time whether it receives an operational signal in response to an operational input. If the operational signal is received, in step S205, the MCU 2 determines whether the operational signal is a signal for controlling the power supply 5. If the operational signal is a signal for controlling the power supply 5, in step S205, the MCU 2 turns off the media player, whereupon the procedure ends. If the operational signal is not a signal for controlling the power supply 5, in step S206, the audio amplifier 9 sets the current volume in an initial volume parameter. In step S207, the timer 5 resets itself to zero, whereupon the procedure goes to step S200.

If no operational signal is received by the input unit 1, in step S202, the MCU 2 determines whether the tracked time T reaches the sleep mode time T0. If the tracked time T does not reach the sleep mode time T0, the procedure returns to step S201 described above. If the tracked time T reaches the sleep mode time T0, in step S203, an intelligent sleep mode is started up, i.e., the media player enters into an initial state of the intelligent sleep mode. In step S204, the input unit 1 detects whether it receives an operational signal. If the input unit 1 receives the operational input, the procedure goes into step S205 described above. If the input unit 1 does not receive the operational signal, in step S208, the MCU 2 determines whether the tracked time T reaches a sleep mode time T0+A*n (n being any natural number except 0.) If the tracked time T does not reach the sleep mode time T0+A*n, in step S209, the electronic apparatus keeps its current volume. If the tracked time T reaches the sleep mode time T0+A*n, in step S210, the audio amplifier 9 decreases the current volume by a certain percent of the initial volume or by a predetermined value. In step S211, the MCU 2 determines whether the current volume is greater than the minimum value. If the current volume is equal to or less than the minimum value, the procedure returns to step S204 described above. If the current volume is greater than the minimum value, in step S212, the input unit 1 detects whether it receives a new operation signal. If the input unit 1 receives the new operation signal, the procure goes to step S205 described above. If the input unit 1 does not receive a signal for controlling the power supply 5, in step S213, the MCU 2 determines whether the elapsed time T reaches a sleep mode time T0+A*(n+1), (n being any natural number except 0.). If the elapsed time T does not reach the sleep mode time T0+A*(n+1), in step S214, the electronic apparatus keeps the current volume. If the elapsed time T reaches the sleep mode time T0+A*(n+1), the procedure goes to step S215 described above, whereupon the procedure ends.

Although the present invention has been specifically described on the basis of the preferred embodiment including the preferred method, the invention is not to be construed as being limited thereto. Various changes or modifications may be made to the embodiments including the method without departing from the scope and spirit of the invention.

What is claimed is:

1. An electronic apparatus for implementing an intelligent sleep mode, the electronic apparatus comprising an input unit, a volume control unit, a timer, and a center control unit connected with the input unit and the timer, wherein:
the center control unit controls the volume control unit to decrease current volume output when no operational input is received by the input unit every first predetermined time period, and turns off the electronic apparatus when satisfying a predetermined requirement.

2. The apparatus as described in claim 1, further comprising a memory for storing a sleep mode time, the first predetermined time period, a second predetermined time period, and a predetermined volume.

3. The apparatus as described in claim 2, wherein the center control unit further starts up the sleep mode when no operational input received by the input unit lasts for the sleep mode time.

4. The apparatus as described in claim 2, the predetermined requirement may be that the current volume is equal to or less than the predetermined volume.

5. The apparatus as described in claim 2, the predetermined requirement may be that a time tracked by the time reaches the second predetermined time period.

6. The apparatus as described in claim 4, wherein the second predetermined time is a sum of all the first predetermined time tracked by the timer.

7. The electronic apparatus as described in claim 1, wherein the center control unit turns off the electronic device when an operational input is received by the input unit and the operational input is a signal to power off.

8. The electronic apparatus as described in claim 7, wherein the center control unit controls the volume control unit to restore the initial volume output when an operational input is received by the input unit and the operational input is not a signal to power off.

9. A method for implementing an intelligent sleep mode, the method providing an electronic apparatus, the electronic apparatus comprising a timer, the method comprising the steps of:
the timer tracking an elapsed time where no operational input is received;
decreasing output volume when the tracked time is equal to a first predetermined time period; and
turning off the electronic apparatus when satisfying a preset requirement.

10. The method as described in claim 9, wherein further comprising the step of starting up the sleep mode when no operational inputs received by an input unit lasts for a sleep mode time.

11. The method as described in claim 9, further comprising the step of turning off the electronic device when an operation input is received by the input unit and the operational input is a power off.

12. The method as described in claim 11, wherein comprising the step of restoring initial volume when a user operation is received by the input unit and the user operation is not for power off.

13. The apparatus as described in claim 9, the predetermined requirement may be that the current volume is equal to or less than the predetermined volume.

14. The apparatus as described in claim 9, the predetermined requirement may be that a time tracked by the time reaches the second predetermined time period.

15. The apparatus as described in claim 14, wherein the second predetermined time is a sum of all the first predetermined time tracked by the timer.

16. A method for implementing a sleep mode on an electronic apparatus, the method comprising the steps of:
starting the sleep mode;
tracking an elapsed time after the starting step when the electronic has not received any user control signal;
reducing an extent if playing parameter after the elapsed time is not up to a preset value;
repeating reducing step based on time value and the parameter value; and
turning off the electronic apparatus after the playing parameter reaches a preset value.
